(19) United States
(12) Patent Application Publication
(10) Pub. No.: US 2014/0236532 A1
(43) Pub. Date: Aug. 21, 2014

(54) TRAILER LENGTH ESTIMATION

(71) Applicant: FORD GLOBAL TECHNOLOGIES, Dearborn, MI (US)

(72) Inventors: Roger Arnold Trombley, Ann Arbor, MI (US); Thomas Edward Pilutti, Ann Arbor, MI (US); Christopher Nave, Ypsilanti, MI (US); John Shutko, Ann Arbor, MI (US)

(73) Assignee: Ford Global Technologies, Dearborn, MI (US)

(21) Appl. No.: 13/772,415

(22) Filed: Feb. 21, 2013

(51) Int. Cl. G01B 21/02

(52) U.S. Cl. CPC G01B 21/02
USPC 702/145; 702/158

(57) ABSTRACT

A vehicle has a wireless receiver located a predetermined distance from a trailer mount. A wireless transmitter on the trailer is located at an end of the trailer opposite the end that attaches to a trailer mount on the vehicle and communicates with the wireless receiver on the vehicle. A controller on the vehicle monitors the power returns of the signal transmitted between the transmitter and the receiver. A hitch angle monitoring system monitors hitch angle over time. The controller monitors power returns of a signal transmitted from the transmitter to the receiver and estimates a distance between the transmitter and the receiver as a function of a path loss propagation of the transmitted signal. The trailer length is equal to the distance estimated by the controller at times when the hitch angle is zero minus the predetermined distance.

### TECHNICAL FIELD

The inventive subject matter is directed to a system and method for estimating the length of a trailer attached to a vehicle.

### BACKGROUND

For a motor vehicle that has a trailer hitched thereto, it is advantageous for a plurality of vehicle systems to use information that is representative of the overall length of the trailer. Many vehicle systems utilize trailer length information as an input to the system which input is manipulated by a controller or microprocessor associated with the vehicle system. Current methods rely on the driver of the vehicle to enter the trailer length information into the vehicle system. This introduces a potential for inaccurate measurements, especially in situations where the driver does not have access to proper measuring equipment and is estimating, or guessing, the length based on observation.

Another potential problem presents itself when a driver enters information for a trailer, or trailer information is entered and stored in a vehicle system, and that trailer is later changed, or replaced, with a different trailer. Many current vehicle systems rely on the driver to indicate that a new trailer has been attached or require confirmation that the same trailer is being used. There may be no way to monitor or verify that the driver is entering accurate information or attached a new miler. Inaccurate information may be a problem when vehicle systems are using the information in their control systems.

### SUMMARY

The inventive subject matter is a system and method for estimating trailer length that does not rely on the driver as the source of inputting the information. The inventive subject matter provides a more reliable estimate of the trailer length that may be used as an input to various vehicle control systems.

A system for estimating length of a trailer coupled to a vehicle, comprising a wireless receiver on the vehicle located a predetermined distance from a trailer mount, a wireless transmitter located at an end of the trailer opposite the trailer mount, means for monitoring a hitch angle, a controller monitoring power returns of a signal transmitted from the transmitter to the receiver and estimating a distance between the transmitter and the receiver as a function of a path loss propagation of the transmitted signal, and setting a trailer length equal to the distance estimated by the controller at times when the hitch angle is zero minus the predetermined distance.

A method executed by a controller on a vehicle for estimating a length of a trailer coupled to the vehicle, comprising the steps of monitoring power returns of a signal transmitted from a wireless transmitter at one end of the trailer to a wireless receiver on the vehicle located a predetermined distance from a trailer hitch, monitoring a hitch angle, estimating a distance between the transmitter and the receiver, the estimated distance being a function of a path loss propagation of the transmitted signal, and setting a trailer length equal to the estimated distance for a zero hitch angle less the predetermined distance.

Hitch angle monitoring may be accomplished in several different ways. A hitch angle sensor in communication with the controller may provide a signal that represents the angle between the vehicle and the trailer. In the alternative, a yaw rate sensor on the vehicle may provide a yaw rate signal representative of the vehicle yaw rate to the controller. The controller monitors the yaw rate signal mer tin to identify a zero hitch angle when a zero yaw rate has been sensed for a predetermined amount of time. In another alternative, the controller may estimate, at predetermined time intervals, a distance between the transmitter and the receiver and compare the estimates to determine the largest estimate of distances between the transmitter and the receiver. The greatest distance is representative of the distance between the transmitter and the receiver at times when the hitch angle is zero.

### DESCRIPTION OF DRAWINGS

FIG. 1 is a block diagram of an automotive vehicle, with a trailer length estimating system of the inventive subject matter, coupled to a trailer; and

FIG. 2 is a flow chart of a method of the inventive subject matter.

Elements and steps in the figures are illustrated for simplicity and clarity and have not necessarily been rendered according to any particular sequence. For example, steps that may be performed concurrently or in different order are illustrated in the figures to help to improve understanding of embodiments of the inventive subject matter.

### DESCRIPTION OF INVENTION

While various aspects of the inventive subject matter are described with reference to a particular illustrative embodiment, the inventive subject matter is not limited to such embodiments, and additional modifications, applications, and embodiments may be implemented without departing from the inventive subject matter. In the figures, like reference numbers will be used to illustrate the same components. Those skilled in the art will recognize that the various components set forth herein may be altered without varying from the scope of the inventive subject matter.

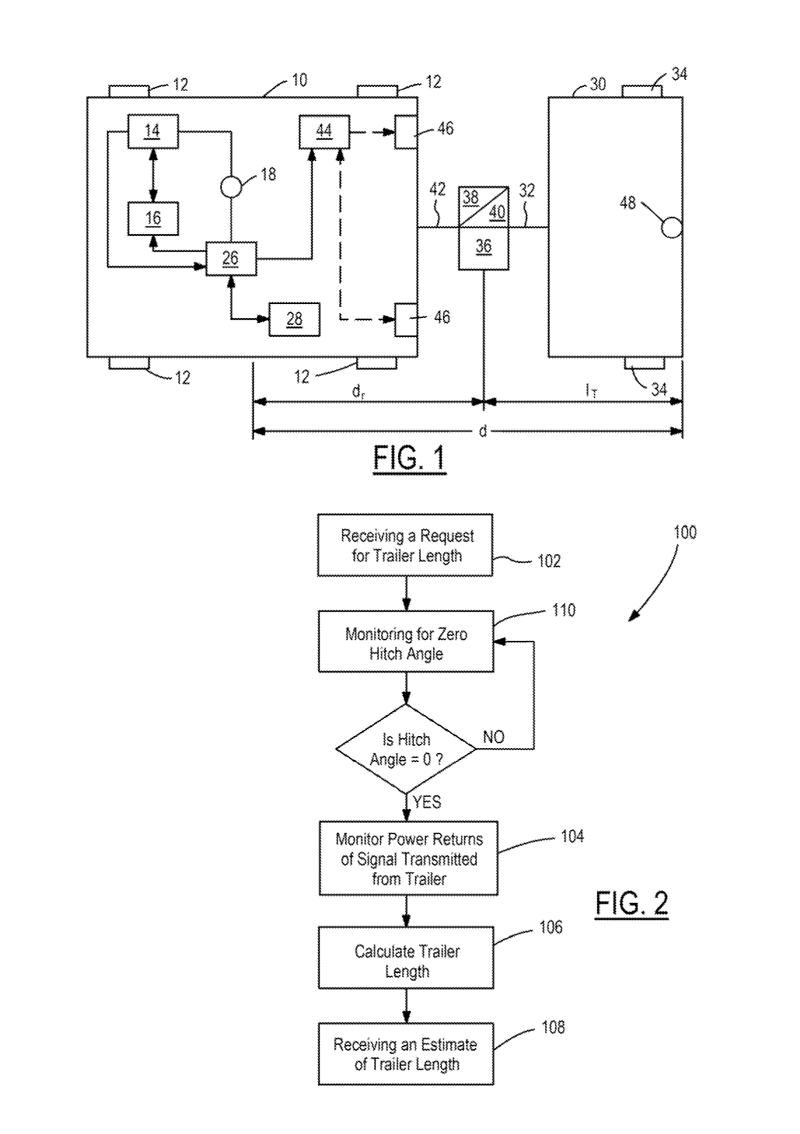

FIG. 1 is an automotive vehicle 10 with a trailer length estimating system of the inventive subject matter. The vehicle 10 has tires 12. The vehicle 10 may also have one or more sensing systems 14 that have a plurality of sensors positioned in on and around the vehicle 10. The vehicle also has a number of different types of control systems 16 that utilize sensor information collected by the sensing systems 14

Sensing systems 14 and vehicle control systems 16 may share sensors with other vehicle dynamic control systems such as a yaw stability control system sensor set or a roll stability control system sensor set. Actual sensors on the vehicle 10 will vary depending on the type of control systems 16 implemented on the particular vehicle 10. Some examples include, but are not limited to, wireless sensors, wheel speed sensors, lidar, radar, sonar, camera(s), and GPS. Angular rate sensors and accelerometers may also be included and are typically mounted on the vehicle along the body frame. For example, a longitudinal acceleration sensor, a lateral acceleration sensor and a vertical acceleration sensor may each be mounted on the vehicle 10 at its center of gravity. A wireless receiver 18 is also included and is mounted at a known vehicle location, such as a central vehicle body position.

Any one of the control systems 16 may have a controller 26, which may be a single centralized vehicle controller or a combination of controllers. If many controllers are used they may be coupled together for communication, arbitration and prioritization among multiple controllers. The controller 26 may be micro-processor based. The controller 26 may comprise a data processing device, such as a non-transitory computer readable medium, and instructions on the computer readable medium for carrying out estimation of trailer length. The controller 26 may have various signal interfaces for receiving and outputting signals. As discussed above, trailer length estimation may be implemented logically in a stand-alone component or in a distributed manner where a plurality of controllers, control units, modules, computers, or the like jointly carry out operations for estimating trailer length.

The controller 26 may be programmed to perform various functions and control various outputs. Controller 26 may have a memory 28 associated therewith. Memory 28 may be a stand-alone memory or may be incorporated into the controller 26. Memory 28 may store various parameters, thresholds, patterns, tables, or maps. For example; parameters may include known, fixed vehicle measurements such as wheel base, vehicle length and distances between pans of the vehicle.

The controller 26 receives information from a number of sensors associated with the sensing systems 14. Again, the sensor systems 14 may include, but are not limited to, speed sensors, a yaw rate sensor, a lateral acceleration sensor, a roll rate sensor, a vertical acceleration sensor, a longitudinal acceleration sensor, a pitch rate sensor, and a steering angle position sensor. These sensors may also be part of an inertial measurement unit (IMU) that would most likely be located at the center of the vehicle body.

A trailer 30 may be towed behind vehicle 10. Trailer 30 may include a tongue 32 and trailer wheels 34. Trailer 30 may also include a trailer brake and electrical components such as lights (not shown in FIG. 1). A wiring harness 36 may be used to couple the trailer to the electrical system of the vehicle 10 and ultimately the harness 36 may couple the trailer to the controller 26.

The trailer 30 is coupled to the vehicle 10, as by a hitch ball or other mount 42 on the vehicle, through a hitch 38 located at the end of the trailer tongue 32. The hitch 38 may have a hitch sensor 40 associated therewith. Alternatively, the hitch sensor 40 may be associated with the mount 42. The hitch sensor 40 is used to determine the angle position of the trailer 30 relative to the vehicle 10. Various types of hitch sensors, such as resistive, inductive, ultrasonic, or capacitive type sensors may be used to determine the relative angel of the trailer 30 with respect to the vehicle 10. Another system that may be used to determine the position of the trailer 30 relative to the vehicle 10 is a reverse aid system 44 on the vehicle 10. The reverse aid system has a plurality of sensors and/or cameras 46 and may be coupled to the controller 26. Reverse aid sensors may be an ultrasonic sensor, a radar sensor, or a combination of the two. Reverse aid sensors are typically located at several locations at the rear of the vehicle 10, such as in the bumper. Other ways to determine the position of the trailer 30 may include cameras located on the trailer, the vehicle or as part of the reverse-aid sensors 44, 46. There are various systems and methods that may be employed to determine the relative angle of the trailer 30 with respect to the vehicle 10. These are too numerous to mention herein and one skilled in the art is capable of applying the most appropriate system and method in accordance with the parameters and configuration of the vehicle and for the trailer.

A wireless transmitter 48 is positioned on the trailer 30 at a known location, preferably at the end of the trailer. This wireless transmitter 48 is in communication with the wireless sensing receiver 18 that is located on the vehicle 10. The wireless sensing receiver 18 has been placed at a known location of the vehicle such that a reference distance, dᵣ, from the receiver 18 to the hitch 38 at the rear of the vehicle 10 is known. Examples of wireless transmitting and receiving devices that may be used are Radio Frequency Identification (RFID), Bluetooth, and the like. As discussed above, the wireless receiver 18 is positioned at a location on the vehicle 10 a predetermined reference distance, dᵣ, from the trailer hitch 38. The wireless transmitter 48 and the wireless receiver 18 are compatible units that transmit and receive signals between the vehicle 10 and the trailer 30. By measuring signals between the transmitter 48 and receiver 18 and monitoring the power returns of signals sent by the transmitter to the receiver, the controller 26 may estimate a distance, d, between receiver 18 on the vehicle 10 and the transmitter 48 on the trailer 30. Ultimately, the trailer length, l_{T}, may be estimated. To get as accurate an estimate of the trailer length, l_{T}, as possible, any signal measurements should be taken when a hitch angle between the vehicle 10 and the trailer 30 is zero. The hitch angle may be monitored at the hitch angle sensor 38, or alternatively, determined using other methods that may include vehicle sensors 14 such as yaw rate sensors or comparing trailer length estimates over time.

The inventive subject matter estimates the trailer length, l_{T}, which may then be used as an input to control algorithms for a variety of vehicle systems such as trailer sway, trailer backup assist, stability control and others. Referring to FIG. 2, a flow chart of the method 100 for estimating a trailer length in accordance with the inventive subject matter. The method 100 may be carried out using the vehicle and trailer architecture discussed above in reference to the vehicle 10 and trailer 30 for FIG. 1. Accordingly trailer length estimation may be supplied to any vehicle system 16 requesting the information.

An operation 102 is performed for requesting trailer length estimation. A request for trailer length estimation may come from a vehicle control system 16 that requires the information as an input to the control algorithm associated therewith. Examples of vehicle control systems 16 that may request trailer length information may be a trailer backup assist system, a trailer sway control system, a trailer brake control system, and a vehicle dynamic control system such as roll stability control or yaw stability control. These are only a few examples of systems 16 that may utilize trailer length information as an input to a control algorithm.

An operation 104 is performed to monitor power returns of signals transmitted from the trailer to the vehicle. Measurements of the signal transmitted by the transmitter on the trailer compared to measurements of the signal received by the receiver on the vehicle will provide the power returns of signals transmitted from the trailer to the vehicle. The power returns of signals transmitted from the trailer and received at the vehicle will be stored in memory and used in the method of the inventive subject matter to estimate a trailer length.

An operation 106 is performed to calculate an estimate of the length of the attached trailer. Estimating the length of the trailer 106 is accomplished by determining the distance between the wireless transmitter on the trailer and the wireless receiver on the vehicle. This distance is a function of path loss of the signal being transmitted and may be derived using the power returns of signals transmitted form the trailer and received at the vehicle. Path loss is proportional to the square of the distance between the transmitter and the receiver, and also to the square of the frequency of the transmitted signal. Signal propagation may be represented by Friis transmission formula:

$${P}_{r} ( d ) = \frac{{P}_{t} {G}_{t} {G}_{r} {λ}^{2}}{{( 4 π )}^{2} {d}^{2} L} \qquad ( 1 )$$

Where Pₜ is the transmission power in Watts, Gₜ and Gᵣ are gains associated with the receiver and the transmitter respectively, λ is the wavelength, L are system losses, and d is the distance between the transmitter and the receiver. Transmission power decreases at a rate proportional to d². Therefore, knowing the path loss associated with the transmitted signal will provide an estimate of the distance between the transmitter and the receiver. Path loss (PL) is represented by:

$$\begin{matrix}{PL}_{dB} = 10 log ( \frac{{P}_{t}}{{P}_{r}} ) = - 10 log ( \frac{{G}_{t} {G}_{r} {λ}^{2}}{{( 4 π )}^{2} {d}^{2} L} ) & ( 2 ) \\ {PL}_{dB} = - 10 log ( \frac{{G}_{t} {G}_{r} {λ}^{2}}{{( 4 π )}^{2} L} ) + 10 log ( {d}^{2} ) & ( 3 ) \\ {PL}_{dB} = - 10 log ( \frac{{G}_{t} {G}_{r} {λ}^{2}}{{( 4 π )}^{2} L} ) + 20 log ( d ) & ( 4 )\end{matrix}$$

Pᵣ decreases at a rate that is proportional to d². The power of the signal received at the receiver may be represented as:

$${P}_{r} ( d ) = {P}_{r} ( {d}_{0} ) {( \frac{{d}_{0}}{d} )}^{2} for d > {d}_{0} > {d}_{f} \qquad ( 5 )$$

Where d is the distance between the transmitter and the receiver, dₒ is a known received power reference point, typically 100 m, and d_{f} is a far-field distance of antenna. Referring back to FIG. 2, the distance, d, may be derived from this formula and represents the overall distance between the transmitter on the trailer and the receiver on the vehicle. Because the receiver is placed at a known location on the vehicle, the trailer length may be estimated by deducting the distance, dᵣ, from the transmitter to the trailer ball, or:

l_{T}=d−dᵣ (6)

An operation 108 is performed for receiving the trailer length estimate at the requesting vehicle system.

The most accurate trailer length estimate of the inventive subject matter will be obtained during periods when the angle between the vehicle and the trailer is zero. That is to say when the vehicle and trailer are in alignment with a zero hitch angle. The method 100 of the inventive subject matter performs an operation 110 to monitor hitch angle thr a zero hitch angle. Upon determination of as zero hitch angle the power returns of the transmitted signal is monitored 104.

Monitoring hitch angle and determining a zero hitch angle may be accomplished in several ways. One way is to use data from a hitch angle sensor. When the hitch angle sensor senses an angle between the vehicle and the trailer that is zero, the operation 104 to monitor power returns of the signal transmitted from the trailer is commenced.

Another way to monitor and determine a zero hitch angle does not require a hitch angle sensor. Instead, the distance, d, is estimated over time and stored. A comparison of values stored over a predetermined period of time is performed to determine a maximum stored value. The maximum stored value coincides with signal measurements that were taken when the hitch angle was zero. As a result, the maximum length of the comparison will be the distance, d, for a zero hitch angle and should be used when estimating, the trailer length, l_{T}.

In yet another alternative to monitor and determine hitch angle, the yaw rate of the vehicle may be monitored over time. A yaw rate sensor is typically available as part of the sensor systems 16 on the vehicle. A zero yaw rate is an indicator that a vehicle is travelling along a straight path. When the yaw rate is at zero, it becomes known that the vehicle is not turning. At first glance, this information alone is not adequate to identify a zero hitch angle because the vehicle may have just stopped turning even though there may be a non-zero hitch angle. However, monitoring yaw rate over time will provide confirmation that the vehicle has driven straight forward for a sufficient predetermined period of time while maintaining a zero or near zero yaw rate. This allows the yaw rate to provide an indication that the trailer has straightened out and it can be inferred that the hitch angle is zero at that point. Upon verification of zero hitch angle 110, the operations to monitor power returns 104 and calculate trailer length 106 are performed.

The predetermined period of time that the yaw rate should remain at zero will be associated with an actual distance the vehicle trailer combination needs to travel to ensure that the hitch angle is zero. This may be determined through testing and stored in the controller memory.

In the foregoing specification, the inventive subject matter has been described with reference to specific exemplary embodiments. Various modifications and changes may be made, however, without departing from the scope of the inventive subject matter as set forth in the claims. The specification and figures are illustrative, rather than restrictive, and modifications are intended to be included within the scope of the inventive subject matter. Accordingly, the scope of the invention should be determined by the claims and their legal equivalents rather than by merely the examples described.

For example, the steps recited in any method or process claims may be executed in any order and are not limited to the specific order presented in the claims. The equations may be implemented with a filter to minimize effects of signal noises. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, arts benefit, advantage, solution to problem or an element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the inventive subject matter, in addition to those not specifically recited, may be varied or otherwise particularly adapted to specific environments, manufacturing specifications, design parameters or other operating requirements without departing from the general principles of the same.

1. A system for calculating a length of a trailer having a transmitter disposed thereon coupled to a vehicle having a trailer mount and a receiver disposed on the vehicle a first distance from the trailer mount, comprising:
a hitch angle monitoring device;
a controller to calculate a second distance between the transmitter and the receiver as a function of a path loss propagation of a signal received by the receiver at times when the hitch angle is zero, and to set a trailer length equal to the second distance minus the first distance.

2. The system as claimed in claim 1 wherein the hitch angle monitoring device further comprises a hitch angle sensor in communication with the controller.

3. The system as claimed in claim 1 wherein the hitch angle monitoring device further comprises:
a yaw rate sensor on the vehicle for providing a yaw rate signal representative of the vehicle yaw rate to the controller; and
the controller monitors the yaw rate signal over time to identify a zero hitch angle when a zero yaw rate has been sensed for a predetermined amount of time.

4. The system as claimed in claim 1 wherein hitch angle monitoring device further comprises the controller:
estimating, at predetermined time intervals, a distance between the transmitter and the receiver, the distance being estimated as a function of a path loss propagation of a signal transmitted from the wireless transmitter to the wireless receiver;
storing a predetermined number of estimated distances; and
comparing the stored distances to determine the greatest distance, the greatest distance is representative of the second distance.

5. A method executed by a controller on a vehicle for calculating a length of a trailer coupled to the vehicle, comprising:
monitoring power returns of a signal transmitted from a wireless transmitter at one end of the trader to a wireless receiver on the vehicle located a predetermined distance from a trailer hitch;
monitoring a hitch angle;
estimating a distance between the transmitter and the receiver, the estimated distance being a function of a path loss propagation of the transmitted signal; and
setting a trailer length equal to the estimated distance at a zero hitch angle less the predetermined distance.

6. The method as claimed in claim 5 wherein the step of monitoring a hitch angle further comprises monitoring a hitch angle from a hitch angle sensor.

7. The method as claimed in claim 5 wherein the step of monitoring a hitch angle further comprises:
receiving, at the controller over time, signal information from a yaw rate sensor, the signal information being representative of a vehicle yaw rate;
monitoring the yaw rate signal for a zero yaw rate; and
detecting a zero hitch angle when the sensed yaw rate is zero for a predetermined amount of time.

8. The method as claimed in claim 5 wherein the step of monitoring a hitch angle further comprises:
estimating a plurality of distances between the transmitter and the receiver as a function of a path loss propagation of the transmitted signal at predetermined time intervals;
storing the plurality of distances;
comparing the stored distances to determine a greatest distance; and
setting the estimated distance at a zero hitch angle equal to the greatest distance.

9. A trailer length calculation system for a vehicle having a trailer mount and a receiver disposed thereon a first distance from the trailer mount, the vehicle being coupled to a trailer having a transmitter, comprising:
a hitch angle monitoring system; and
a controller configured to set the length of the trailer equal to the difference between the first distance and a second distance, wherein the second distance is calculated to be a function of a path loss propagation of a signal received by the receiver when the hitch angle is zero.

10. The system as claimed in claim 9 wherein the hitch angle monitoring system further comprises a hitch angle sensor outputting a signal representative of an angle between the vehicle and the trailer.

11. The system as claimed in claim 10 wherein the hitch angle monitoring system further comprises:
a yaw rate sensor on the vehicle for providing a yaw rate signal representative of the vehicle yaw rate to the controller; and
controller monitors the yaw rate signal over time to identify a zero hitch angle when a zero yaw rate has been sensed for a predetermined amount of time.

12. The system as claimed in claim 10 wherein the hitch angle monitoring system further comprises the controller configured to:
estimate, at predetermined time intervals, a distance between the transmitter and the receiver, the distance being estimated as a function of a path loss propagation of a signal transmitted from the wireless transmitter to the wireless receiver;
store a predetermined number of estimated distances; and
compare the stored distances to determine the greatest distance, the greatest distance is representative of the second distance.
